(19) United States
(12) Patent Application Publication
(10) Pub. No.: US 2013/0146221 A1
(43) Pub. Date: Jun. 13, 2013

(54) GRAPHENE-BASED MEMBRANES AS ELECTRON TRANSPARENT WINDOWS FOR AMBIENT PRESSURE X-RAY PHOTOELECTRON SPECTROSCOPY

(71) Applicants: Andrei Kolmakov, Carbondale, IL (US); Dmitry Dikin, Carbondale, IL (US); Sebastian Gunther, Carbondale, IL (US); Jiaxing Huang, Carbondale, IL (US)

(72) Inventors: Andrei Kolmakov, Carbondale, IL (US); Dmitry Dikin, Carbondale, IL (US); Sebastian Gunther, Carbondale, IL (US); Jiaxing Huang, Carbondale, IL (US)

(73) Assignee: Southern Illinois University Carbondale, Carbondale, IL (US)

(21) Appl. No.: 13/713,628

(22) Filed: Dec. 13, 2012

Related U.S. Application Data
(60) Provisional application No. 61/569,888, filed on Dec. 13, 2011.

(51) Int. Cl. B32B 38/00

(52) U.S. Cl. CPC B32B 38/0004
USPC 156/252

(57) ABSTRACT

Some embodiments of the invention include a method for preparing a carbon-containing membrane. The method includes preparing a carbon-containing solution and then washing and filtering the carbon-containing solution. The method further provides adding a volume of the washed and filtered carbon-containing solution to a receptacle that includes an aqueous solution. After a predetermined amount of time, the carbon-containing solution will equilibrate and form sheets of carbon-containing materials that float on a surface of the aqueous solution. The method further includes defining an aperture through at least a portion of a substrate and then inserting the substrate in the receptacle so that at least a portion of the carbon-containing sheets adhere to the substrate. In addition, the method further includes thermally treating the membrane to improve its molecular impermeability.

### CROSS-REFERENCE TO RELATED APPLICATIONS

The present application claims priority under 35 U.S.C. §119(e) to U.S. Provisional Application No. 61/569,888 filed on Dec. 13, 2011, the entire contents and disclosure of which are herein incorporated by reference.

### FIELD

The invention relates generally to materials and systems capable of use for imaging systems, and in particular to graphene-based windows for environmental cell photoelectron spectroscopy.

### BACKGROUND

The requirement for high-vacuum conditions in conventional electron spectroscopy studies, such as X-ray photoelectron spectroscopy (XPS), Auger electron spectroscopy (AES), and electron energy loss spectroscopy (EELS), imposes an obstacle for analyzing interfacial physiochemical processes under ambient conditions. Consequently, there has been a persistent trend, mainly in the field of heterogenous catalysis and environmental remediation, to overcome the so-called “pressure gap” and observe processes taking place at surfaces and interfaces under operating conditions, namely elevated or ambient gas pressure or liquid environments. Some progress has been made in this regard in high-resolution transmission electron microscopy (HRTEM) coupled with the analytical power of EELS and X-ray fluorescence spectroscopy using open environmental cells (E-cells). Since the 1930s, elevated pressure has been used in environmental studies using transmission electron microscopy (TEM) and scanning electron microscopy (SEM) by implementing non-permeable windows that have been made from materials such as aluminum, collodion, or amorphous carbon. Later, microfabricated SiO₂, Si₃N₄, or 10-100 nanometer (nm)-thick polymer membranes were used, which are highly transparent to the commonly used 10-300 keV electrons and 1×10³ to 1×10⁴ eV X-rays. This closed-cell design, in combination with a variety of commercially available microfabricated membranes, has boosted activity in environmental electron microscopy and X-ray sectromicroscopy research.

However, it still remains a challenge to adapt powerful, surface tools such as XPS or AES (i.e., tools in which the action is based on the detection of emitted electrons with relatively low kinetic energy in the general range of 1×10² to 1×10³ eV) to explore objects at ambient conditions. This difficulty is mainly due to the short electron inelastic mean free path (IMFP), λ_{IMFP}, in dense media, which is of the order of a nanometer in condensed matter and a micrometer (μm) in gasses at atmospheric pressure (i.e., a one-thousand fold difference). To date, the main impediments have been largely resolved through the development of an electron energy analyzer with differentially pumped lens systems, which can decouple the spectrometer from the high-pressure ambient conditions of the sample placed immediately adjacent to the analyzer entrance aperture, as shown in FIG. 1A. Other conventional systems use liquid microjets and droplet train methods, which have been implemented to probe analytes inside highly volatile solvents. In spite of some successes with these systems, the conventional systems are generally accessible only in a few laboratories and synchrotron facilities, which limits the span of research to a generally small number of users.

### SUMMARY

Some embodiments of the invention include a method for preparing a carbon-containing membrane, such as a graphene and/or a graphene-oxide membrane. In some embodiments, the method can include preparing a carbon-containing solution and then washing and filtering the carbon-containing solution. The method may further provide adding a volume of the washed and filtered carbon-containing solution to a receptacle, which may include an aqueous solution. In some embodiments, after a predetermined amount of time, the carbon-containing solution will substantially or completely equilibrate and can form sheets of carbon-containing material, such as graphene sheets or graphene-oxide sheets, which float on a surface of the aqueous solution. The method may further include defining at least one aperture through at least a portion of a substrate and then inserting the substrate in the receptacle so that at least a portion of the carbon-containing sheets adhere to the substrate. In some embodiments, when adhering to the substrate, the carbon-containing sheets can cover at least a portion of the aperture. Moreover, in some embodiments, the carbon-containing membrane can be thermally treated to improve molecular impermeability properties.

Additional objectives, advantages and novel features will be set forth in the description which follows or will become apparent to those skilled in the art upon examination of the drawings and detailed description which follows.

### BRIEF DESCRIPTION OF THE DRAWINGS

FIG. 1A is a simple diagram of a conventional XPS system;

FIG. 1B is a simple diagram of one embodiment of an imaging system;

FIGS. 2A-2I are simplified illustrations of a method of assembling one embodiment of a graphene oxide (GO) window for use with the imaging system of FIG. 1B;

FIG. 3A is a simplified illustration of an experimental setup for testing one embodiment of an imaging system;

FIGS. 3B-3D are data obtained from the use of the experimental setup of FIG. 3A;

FIGS. 4A-4C are data detailing measurements of one embodiment of a GO window for use with the imaging system of FIG. 1B;

FIGS. 5A-5F are results from experiments testing GO windows for use with one embodiment of an imaging system;

FIG. 6 is the result of an XPS experiment using a GO window for use with one embodiment of the invention;

FIG. 7A is a perspective view of a disc and aperture for use with one embodiment of an imaging system;

FIGS. 7B-7E are simplified illustrations of one embodiment of a procedure for forming a GO membrane for use with one embodiment of an imaging system;

FIGS. 7F-7L are simplified illustrations of one embodiment of a procedure for forming a GO membrane for use with one embodiment of an imaging system;

FIGS. 7M and 7N are images of a GO membrane prepared using the disc of FIG. 7A;

FIGS. 8A and 8B are atomic force microscopy and reflected polarized light images of a GO membrane or film;

FIG. 8C is a histogram detailing results of a distribution of GO film heights of the GO membrane of FIGS. 8A and 8B;

FIGS. 9A-9C are images of a GO membrane undergoing pressure differential testing;

FIG. 10 is a simplified illustration of one embodiment of an environmental cell;

FIGS. 11A-11D are data from experiments testing GO membranes for use with one embodiment of an imaging system;

FIGS. 12A-12H are results from experiments testing GO membranes for use with one embodiment of an imaging system; and

FIGS. 13A-13D are results from experiments testing GO windows for use with one embodiment of an imaging system.

Corresponding reference characters indicate corresponding elements among the view of the drawings. The headings used in the figures should not be interpreted to limit the scope of the claims.

### DETAILED DESCRIPTION

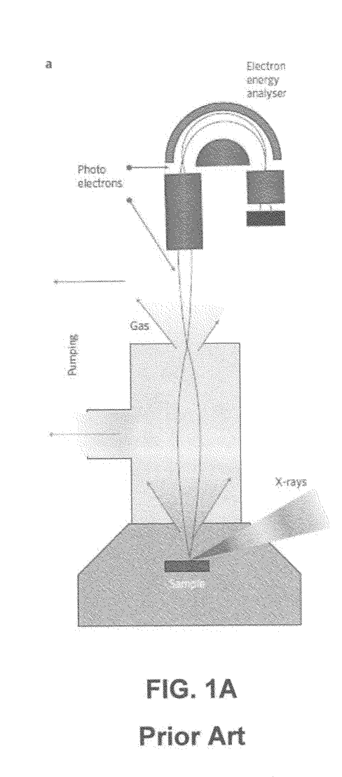

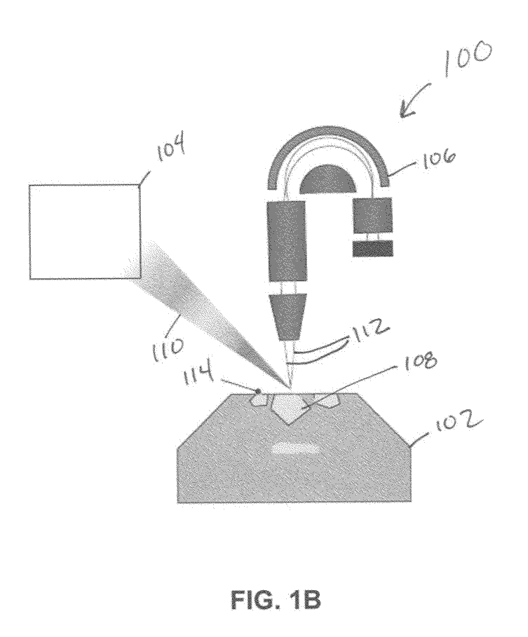

Referring to the drawings, embodiments of an imaging system are illustrated and generally indicated as 100 in FIG. 1B. For example, in one embodiment, the imaging system 100 can be used in basic, applied, and/or translational research and developments. For example, some embodiments of the imaging system 100 can be used to meet some or all needs of research related to material, biological, medical, chemical, catalytic, and other research areas to study dynamic processes in a substantially native environment (e.g., for in vivo and/or in situ microscopy of objects immersed in dense gaseous and liquid environments).

In some embodiments, the imaging system 100 can be configured using some or many components of known, conventional imaging systems. For example, the imaging system 100 can be generally configured as one or more of the following systems: X-ray photoelectron spectroscopy (XPS), an Auger electron spectroscopy (AES), and/or an electron energy loss spectroscopy (EELS). In other embodiments, the imaging system 100 can be configured to employ high-resolution transmission electron microscopy (HRTEM) coupled with the analytical power of EELS and X-ray fluorescence spectroscopy using open environmental cells (E-cells), transmission electron microscopy (TEM), and/or scanning electron microscopy (SEM). In yet other embodiments, the imaging system 100 can be adapted to operate as any other conventional spectroscopy or microscopy system. Future discussions in this paper may refer to the imaging system 100 being configured as an XPS system; however, these discussions are intended only as examples for illustrating some embodiments of the imaging system 100 and are not intended as limitations of the disclosure.

For example, in some embodiments, the imaging system 100 can be generally configured as an XPS system. The imaging system 100 can include one or more E-cells 102, a radiation source 104, and an electron energy analyzer 106. Moreover, the E-cells 102, which are described in greater detail below, may be configured to support a liquid, solid, and/or gaseous sample or analyte 108 for analysis using the imaging system 100. In addition, the imaging system 100 may generally operate as an XPS system. For example, the radiation source 104 can produce one or more bursts of radiation 110 (i.e., X-rays shown in FIG. 1B) that are directed toward the sample 108. After contacting the sample 108, photoelectron beams 112 may be emitted from the sample 108 and directed generally toward and/or through the electron energy analyzer 106. Once in the electron energy analyzer 106, the photoelectron beams 112 may be detected and the resulting raw data can be processed and analyzed using one or more algorithms stored on a computing device (not shown) to produce a visualization of the sample 108.

In some embodiments, the E-cell 102 can be configured to enable study of the sample or analyte 108 in a generally controlled atmosphere (e.g., controlled pressure, temperature, relative humidity, etc.). Accordingly, in some embodiments, it can be desirous to place a membrane or other structure over a portion of the E-cell 102 (e.g., before or after depositing the sample 108 within the E-cell 102) that is relatively or completely impermeable to environmental factors that can alter the atmosphere within the E-cell 102, but configured to enable the radiation 110 and photoelectron beams 112 to ingress and egress from the E-cell 102, respectively. For example, in some embodiments, the E-cell 102 may include a membrane 114 to provide for atmospheric control and transmission of radiation 110 and photoelectron beams 112.

In some embodiments, the membrane 114 can exhibit a generally thin configuration. For example, in some embodiment, the membrane 114 can have a thickness less than one millimeter (mm). In some particular embodiments, the membrane 114 can have a thickness less than one micron (μm). For example, in one embodiment, the membrane 114 can have a thickness less than or substantially equal to one nanometer (nm). As a result of at least some of these thicknesses, radiation 110 and photoelectron beams 112 can readily pass through the membrane 114.

In some embodiments, the membrane 114 can be composed of one or more carbon-containing materials. For example, in some embodiments, the membrane 114 is at least partially composed of graphene oxide or graphene. In other embodiments, the membrane 114 can be composed of other materials, such as, but not limited to WS2BN, MoS₂, NbSe₂, Si₂Sr₂CaCu₂Oₓ, Bi₂Te₃, and others. As a result of forming the membrane 114 from one or more of these materials, the membrane 114 can be configured to substantially or completely seal the E-cell 102 to provide a relatively or completely controlled atmosphere therewithin.

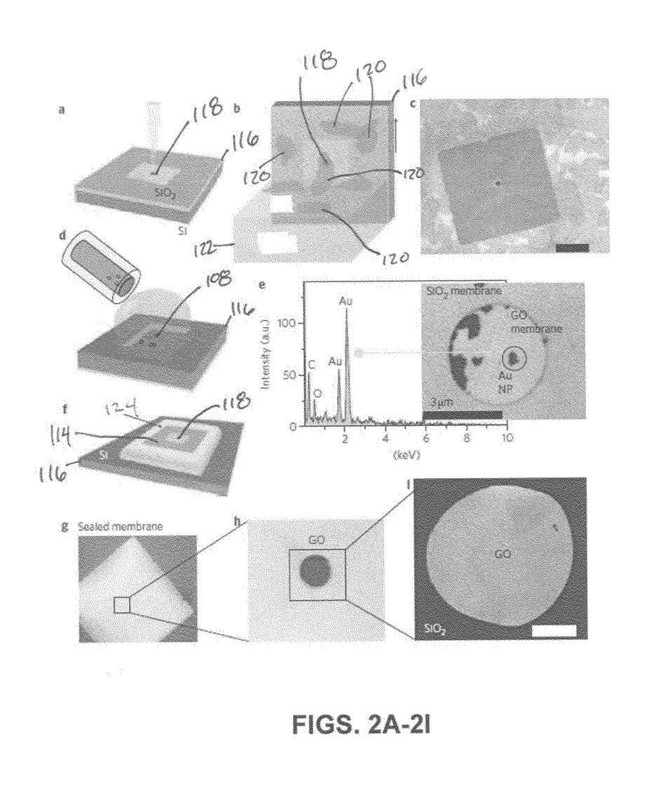

Referring now to FIG. 2, the membrane 114 can be assembled according to some embodiments of the imaging system 100. The following discussion is intended as only an example of assembling a membrane 114 and an E-cell 102 and is described in greater detail in the Examples section below. This description is not intended to limit the scope of the disclosure to this or any other method of manufacturing or preparing a membrane 114. For example, although the following discussion uses graphene oxide as the composition from which the membrane 114 is formed, other materials, such as graphene, can be readily used in preparing the membrane 114.

In some embodiments, the method of assembling a membrane 114 can include providing a substrate 116. As shown in FIG. 2A, the substrate 116 can be a multi-layered configuration. For example, one of the layers can be made from SiO₂ and another layer can be made from Si. In other embodiments, the substrate 116 can be made from other materials and/or may be only a single-layered configuration. In addition, in one embodiment, one or more apertures 118 can be defined through at least a portion of the substrate 116. For example, a focused ion beam can be used to mill at least one aperture 118 through a portion of the substrate 116.

In some embodiments, a plurality of graphene-oxide (GO) sheets 120 can be prepared using substantially conventional methods either before or after preparing the substrate 116. For example, a GO solution can be prepared, filtered, washed, and added to a receptacle 122 (e.g., a trough) that is holding an aqueous solution (e.g., water). In some embodiments, the GO solution can be “floated” on top of the aqueous solution and allowed to equilibrate to form the GO sheets 120 that reside on top of aqueous solution. Then, as shown in FIG. 2B, the GO sheets 120 may be deposited on at least a portion of the substrate 116 by inserting the substrate 116 at least partially into the receptacle 122 and slowly removing the substrate 116 so that the GO sheets 120 adhere thereto. For example, when adhering to the substrate 116, the GO sheets 120 can cover at least a portion of the one or more apertures 118. Moreover, once deposited on the substrate 116, the GO sheets 120 can dry and form the membrane 114, which may include a thickness of between about 1 and about 2 nm.

In addition, as shown in FIG. 2D, the sample 108 can be added to the substrate 116. For example, the sample 108 can be deposited on a side opposing the membrane 114 so that the sample 108 adheres or is deposited adjacent to the membrane 114 for later imaging use. In some embodiments, before proceeding to later steps in the method, if the sample 108 includes a volume of liquid, the sample 108 can be dried so that little to no liquid remains and the sample 108 is adhered to the membrane 114 and/or a portion of the substrate 116.

Furthermore, in some embodiments, a sealant 124 can be placed around at least a portion of the membrane 114 and/or the substrate 116. As shown in FIG. 2F, the sealant (e.g., a UV-curable sealant) can be placed along a perimeter of the substrate 116 and cured to seal the E-cell 102. As a result, the combination of the sealant 124 and the membrane 114, the environment within the substrate 116 can remain relatively constant. As discussed in greater detail below, the membrane 114 can be assembled in other manners for use with the imaging system 100.

### EXAMPLES

The following discussion is intended only as examples of some embodiments of the invention. The details set forth below are not intended to limit the scope of the disclosure, but are rather to provide exemplary uses of some embodiments of the invention.

### Example 1

Fabrication and characterization of graphene oxide membranes and environmental cells (E-cells).

Referring to FIGS. 2A-21, graphene oxide (GO) sheets were prepared with graphite powders using a modification of the method disclosed in Hummers, W. S. & Offeman, R. E., “Preparation of Graphitic Oxide,” J. Am. Chem. Soc. 80 1339 (1958), which is herein incorporated in its entirety by reference. Using this method, 2 grams of graphite, 1 gram of NaNO₃, and 46 mL of sulfuric acid were stirred together in an ice bath. Six grams of KMnO₄ was added slowly. Once mixed, the solution was transferred to a 35° C. water bath and stirred for approximately one hour, forming a thick paste. Approximately 80 mL of water was added and the solution stirred for about one hour while the temperature of the water bath was gradually raised to 90° C. Next, 200 mL of water was added, followed by the slow addition of 6 mL of hydrogen peroxide (at a concentration of about 30%), causing the solution to change color from dark brown to yellow. The warm solution was then filtered and washed with three aliquots of 200 mL 10% hydrochloric acid, followed by 200 mL of water. The filter cake was dispersed in water by mechanical agitation and stirred overnight. The dispersion was allowed to settle and the top clear, yellow dispersion was subject to dialysis for a month.

After dialysis, the Langmuir-Blodgett assembly method was used to assemble the GO, as disclosed in Cote et al, “Flash Reduction and Patterning of Graphite Oxide and its Polymer Composite,” J. Am. Chem. Soc. 131, 11027-11032 (2009), which is herein incorporated by reference. Briefly, the dialyzed GO was diluted using a 5:1 methanol:water solution. A receptacle (e.g., a trough) was cleaned with chloroform and then filled with deionized water. The GO solution was spread drop-wise onto the water surface using a syringe, to a total volume of between about 10 to about 15 mL, and then the film was allowed to equilibrate for at least 20 minutes. As a result, individual 100-1000 μm² GO sheets formed, as illustrated in FIGS. 2B and 2C. For example, after equilibration, the GO layer was compressed to form a GO monolayer at the air-water interface.

At least a portion of the experimental examples detailed below were carried out using conventional frames or similar structures (e.g., 200 μm thick) with 50 nm thick 100×100 μm² SiN₄ (or SiO₂) windows as primary membranes or substrates. Windows to be used with GO deposition were generally refined by ion-beam milling of the primary membrane using a Helios NanoLab Dual Beam SEM/Focused Ion Beam (FIB). For example, one or more 3-10 μm apertures were milled in the primary membranes using a FIB, which helped ensure the mechanical stability of the windows, as illustrated in FIG. 2A. Moreover, in order to eliminate charging, the surface of the primary membranes was coated with about 10 to about 20 nm of gold (Au) before GO deposition. As shown in FIG. 2B, the substrates (i.e., the windows or primary membranes) were vertically dipped into the receptacle and slowly pulled up at a rate of about 2 millimeters per minute, which enabled the GO sheets to adhered to the primary membrane. As a result, at least a portion of the apertures were covered by one or more layers of the GO sheets. In addition, after attaching to the primary membranes, the GO sheets were allowed to dry for a predetermined amount of time to form GO membranes over the one or more apertures. Moreover, in some embodiments, an additional thermal treatment was used to improve molecular impermeability of the primary membrane.

In addition, three types of samples were used in some of the following studies. The first sample type had unconjugated mono-dispersed 50 nm gold colloids drop-cast onto the back of the membrane and dried. In the second sample type, to evaluate the transparency of the freestanding GO membranes, about 5 to about 10 nm of gold was d.c. sputtered on the backside of the GO membrane, as shown in FIGS. 2D and 2E. In order to protect the front side of the membrane from unintentional deposition of gold during the sputtering, the periphery of the front side of the membrane was generally sealed using a ring made of Gel-Film.

In the third sample type, 3 M Nal aqueous solution in double distilled water was used. Specifically, about 1×10⁻² μL of analyte was filled in a compartment of the substrate and a second silicon wafer was placed over the filled compartment to create a sealed E-cell. The excess water was removed and the entire assembly sealed using an Ultraviolet-curable Norland optical adhesive NOA-81, as illustrated in FIG. 2F. A strip of conducting silver paste was drawn between the front side of the cell and the metal support to group the front part of the substrate. Such a cell is generally compatible with the typical vacuum (1×10⁻⁹ torr) of the main chamber of an imaging system (e.g., an XPS system).

In addition, prior to ultra-high vacuum (UHV) measurements, the mechanical integrity and vacuum compatibility of the sealed sample cells were tested in an intermediate-vacuum interlock chamber. For example, as shown in FIGS. 2G and 2H, because of the few-micron size of the GO windows, in situ photoelectron spectroscopy measurements with such a cell may need microprobe XPS and a sufficiently intense photon source provided by the scanning photoelectron microscope (SPEM) operated by a synchrotron light source. In using SPEM, the X-ray beam was focused onto a spot with a diameter of about 100 nm using Fresnel zone plate optics. Moreover, the local XPS spectra of the mesoscopic sample was obtained by raster-scanning the sample with respect to the focused beam while simultaneously monitoring emitted photo-electrons, transmitted photons, and/or the beam-induced sample photocurrent.

By way of example only, SEM imaging was performed in reflection mode by collecting secondary electrons, and also in transmission mode using a two-segment, solid-state STEM detector with either bright-field or dark-field electron collection. The imaging conditions were at an acceleration voltage of 10 kV, beam current of about 1×10⁻¹¹ Amps, and an electron dose of about 1 mC per cm². TEM imaging was carried out with a JEOL JEM-2100F FAST TEM using an acceleration voltage of 200 kV.

Atomic force microscopy (AFM) images were recorded using a Park-XE100 microscope. The scanning probe microscope (SPM) was equipped with a silicon cantilever with a force constant of 40 Newtons per meter and a curvature radius of 10 nm. AFM was operated in non-contact mode at a resonance frequency of 270 kHz. Image scanning was performed with a speed of 0.5 Hz, which corresponds to one line per second. SPEM measurements were carried out at the ESCA microscopy beamline in synchrotron facilities. As previously mentioned, the incident soft X-ray photon beam (e.g., about 200-1,400 eV) was focused to a small spot with a diameter of about 100 nm at the sample surface. The sample could be scanned with an accuracy of about 10 nm in front of the beam. The measured flux in the probe was 1×10⁹ to 1×10¹⁹ photons per second. For XPS spectra and imaging, a hemispherical 100 mm energy analyzer with a 16-channel detector and an energy resolution better than 200 meV was used. XPS spectra analysis and image data was processed using IGOR Pro Software. For quantitative intensity comparisons, peak areas were determined after Shirley background subtraction. The oxygen 1s spectra were fitted assuming a Doniach Sunjic line shape of low asymmetry (α=0.02), a Lorentzian linewidth of 0.25 eV, and a Gaussian linewidth ranging from between 1.8 and 2.6 eV and subtracting a linear background. The peak positions of the indicated species were 532.0-532.5 eV (C═O, C—OH, SiO₂, O═C—OH, which are species of the membrane), 533.6 eV (liquid water), and 536.8 eV (water vapor).

### Experimental Results

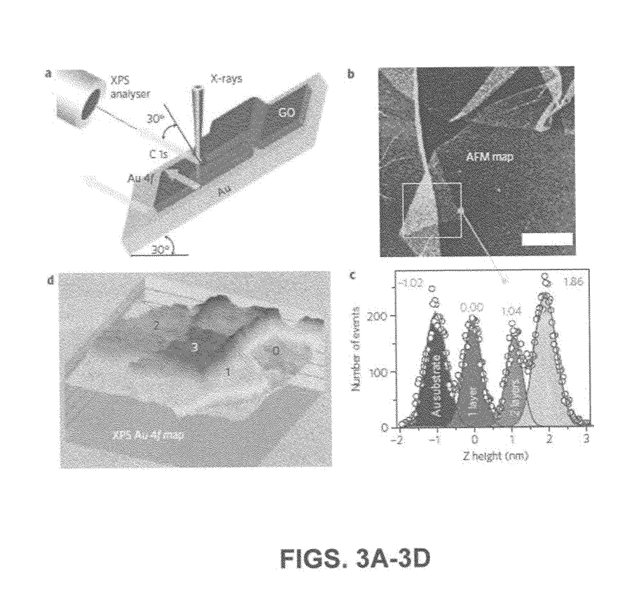

In using some embodiments of the invention, for spectroscopic and signal attenuation tests, gold 4f core levels were selected. These levels provide the combination of appreciable photo-ionization cross-section (e.g., about 1-4 Mbarn) for excitation with soft X-rays (e.g, about 650 and 777 eV) and relative low binding energy (e.g., E_{b}=83.9 and 87.6 eV for 4f_{5/2} and 4f_{7/2}, respectively), which means that the kinetic energy of the emitted gold 4f photoelectrons is high enough for penetration through the GO membrane of the window. For example, the principle and geometry of the experimental setup using GO layers to form a GO membrane on a gold/silicon substrate can be seen in FIG. 3A. The general morphology of the deposited GO layers on the gold/silicon substrate was inspected optically with SEM and AFM. The average lateral dimension of the individual GO pieces, flakes, and/or other amorphous structures was around 20 μm, with folding, overlapping, and wrinkle formation observed. As generally illustrated in FIG. 3B, the AFM images indicate that the majority of the GO pieces are single layer-thick individual GO sheets. From the Z-height histogram shown in FIG. 3C, which was taken from a representative area of images similar to those shown in FIG. 3B, the thickness of the individual GO layer can be inferred to be about 1.0±0.07 nm. The discrete electron transparency for GO sheets of different thicknesses is illustrated by the three-dimensional gold 4f intensity map in FIG. 3D, in which patches of single, double, triple, quadruple, etc. GO layers can be identified.

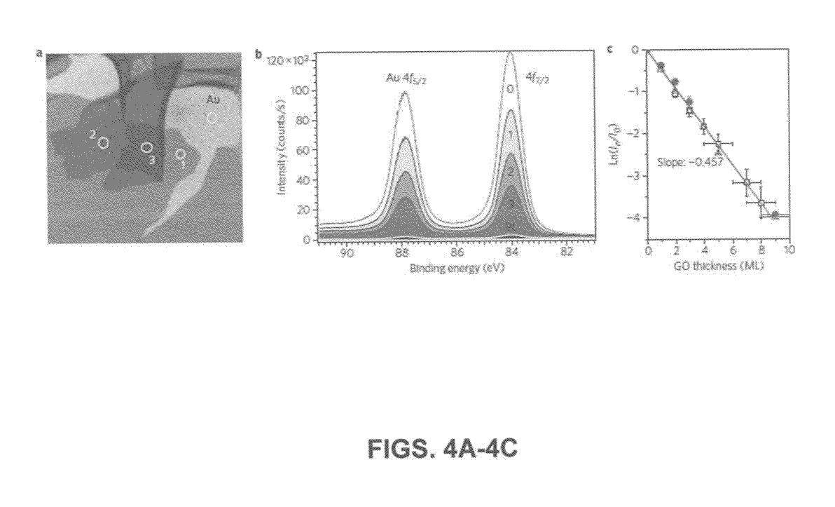

As shown in FIG. 4A, the same 25.6×.25.6 μm² gold 4f image from FIG. 3D is depicted in a two-dimensional representation, where the variations of the grey scale reflect the gold 4f signal attenuation by the multiply folded and overlapping GO layers covering the gold film. The gold 4f spectra shown in FIG. 4B were collected at selected locations with known thicknesses. This spectra data quantitatively supports the information obtained by the gold 4f images. The gold 4f spectra line shape corresponds to metallic gold and the gold 4f intensity drops exponentially with increasing numbers of covering GO sheets due to the inelastic photoelectron scattering. The quantification of the attenuation effect is commonly obtained from the ratio Iₙ/Iₒ, where Iₙ and Iₒ are the gold 4f intensity attenuated by n GO layers and from a bare gold substrate (i.e., n=0), respectively. The log Iₙ/Iₒ plot versus the number of GO layers n on top of the gold substrate in FIG. 4C shows an exponential dependence with the standard deviation. Using the standard relationship of the straight-line approximation (SLA) for the attenuated gold 4f signal in n GO layers due to the inelastic electron scatting, the following equation can be derived:

$$\frac{\text{?}}{\text{?}} = exp ( - d / \text{?} \cdot cos θ ) \\ \text{?} \text{indicates text missing or illegible when filed} \qquad ( 1 )$$

where d is the thickness of the GO overlayer, λ_{IMFP} is the inelastic mean free path of the gold 4f electrons in GO, and θ is the emission angle with respect to the sample normal. By substituting λ_{IMFP} with the effective attenuation length (λ_{EAL}) to account for elastic scatting effects, the), λ_{EAL} value for GO can be obtained. Unlike graphene, the reported experimental data for the GO monolayer thickness scatters significantly from 0.35 nm to 1.7 nm. One of the reasons for this scattering is that the thickness of GO results from different degrees of thermal and chemical reduction of the film/membrane and intrinsic surface roughness. In addition, the X-ray beam-induced effects cannot be excluded, such as the photothermal de-oxygenation reaction. Accordingly, instead of the thickness of GO, d_{GO}, it is more feasible to measure the ratio of λ_{EAL}/d_{GO}, which can be obtained from the experimental values of Iₒ/Iₙ from the SLA-derived expression:

$$\frac{\text{?}}{\text{?}} = n \cdot {( cos θ \cdot ln ( \frac{\text{?}}{\text{?}} ) )}^{- 1} \\ \text{?} \text{indicates text missing or illegible when filed} \qquad ( 2 )$$

The best fit gives λ_{EAL}/d_{GO}=2.53±0.05, where the only unambiguous number of the GO layers (n<5) is used, as shown by the line in FIG. 4C. Taking the AFM single GO layer thickness, d_{GO} is about 1 nm, the effective attenuation length for 567 eV photoelectrons and 0=30° is estimated as λ_{EAL} is about 2.5 nm.

In addition, the enhanced transparency of the GO membrane for photoelectrons has been confirmed by the ability to collect XPS spectra and images from samples placed on the back side of the suspended GO membranes or windows. Due at least in part to the appreciable λ_{EAL} value, this shows that windows with GO membranes consisting of one to four layers can be used for quantitative in situ XPS. Comparing the data obtained with the two types of gold samples, the photoelectron signal from the percolating gold nanoparticle layer evaporated directly on the back side of the GO membrane is much higher than the one form the drop-cast colloidal gold, which is most likely due to presence of surfactant molecular layers at the interface between the gold colloid nanoparticles and membrane, in the latter case. These comparative experiments indicate that for this technique, the immediate proximity of the tested sample to the membrane surface is a relevant feature. In some embodiments, the proximity can be a critical feature, but does not have to be in all embodiments.

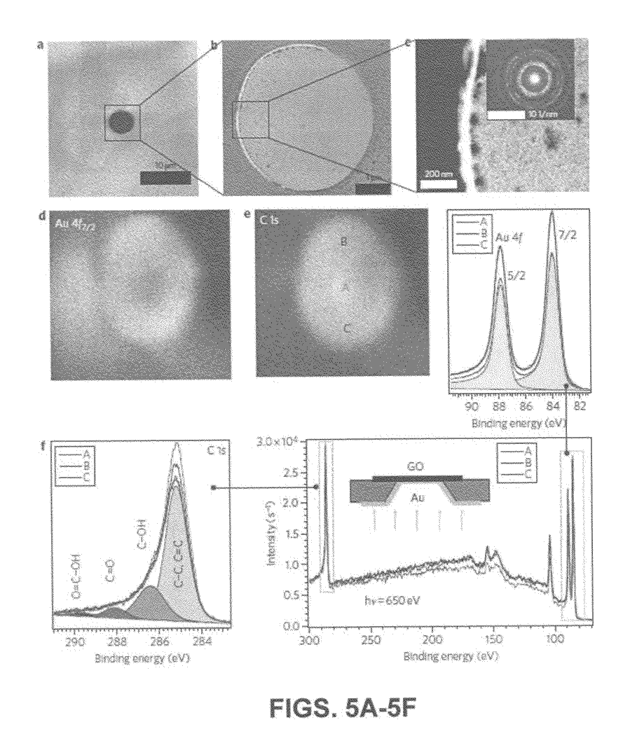

For example, the SEM image of FIG. 5A shows an individual GO flake covering an aperture defined through the SiO₂ substrate. The TEM/HRTEM images in FIGS. 5B and 5C, respectively, depict the same membrane after deposition of a few nanometers of gold onto the back side of the membrane. The morphological electron microscopy data were complemented with SPEM chemical mapping of the same membrane, as shown in FIGS. 5D and 5E. In comparing the TEM/HRTEM and the SPEM images before and after gold deposition, these data indicate that, similar to graphene, a few monolyaer-thick GO membrane can be considered a promising sample support for TEM/HRTEM imaging. These data further indicate that the GO membrane preserves its mechanical integrity even after being loaded by up to a few nanometer thick metal layers of prefabricated nanostructures (i.e., gold nanoparticles in this case).

Moreover, referring back to FIGS. 5B and 5C, which illustrate TEM and HRTEM images, respectively, these images reveal the morphology of a gold deposit composed of percolating single-crystal nanoparticles, which may be typical for Volmer-Weber type growth mode of metals on weakly interacting substrates, such as graphite or metal oxides. The HRTEM image and selected area electron diffraction (SAED) pattern of the GO membrane/gold sandwich in FIG. 5C are generally typical for randomly oriented gold nanoparticles with major lattice fringes indexed to a polycrystalline gold sample with face-centered cubic crystallites. Moreover, the SPEM data of FIGS. 5D-5F provide complementary information about the chemical status of the gold specimen surface and the interface with the GO membrane/window. For this membrane, an effective thickness of about 3-4 monolayers of GO was estimated, based on the I_{Cis}/I_{Au4f} ratio recorded for GO layers with know thickness. The quality of the XPS survey and gold 4f and carbon 1s spectra taken at different locations (as shown in FIG. 5F) is sufficient to identify the chemical status of the sample on the back side of the membrane. The fit of the gold 4f doublet corresponds to unreacted metallic gold. The deconvoluted carbon 1s spectrum of the GO membrane contains low weight C═O, C—OH components. They resemble the carbon 1s spectra of thermally reduced GO, which may be the result of oxygen desorption induced by prolonged electron or X-ray irradiation during the measurements. The gold 4f_{7/2} (as shown in FIG. 5D) and carbon 1s (as shown in FIG. 5E) chemical maps of the GO membrane indicate certain inhomogeneities in the gold and carbon distribution across the GO membrane area, which may be due to radiation damage. This problem may be alleviated in some embodiments because of a single-use E-cell configuration for in situ XPS characterization so that after exposure to a radiation source for imaging purposes, the E-cell is securely discarded. As a result, any damage to the GO membrane resulting from the imaging process is irrelevant for the next use because a new E-cell with a previously-unused GO membrane is employed.

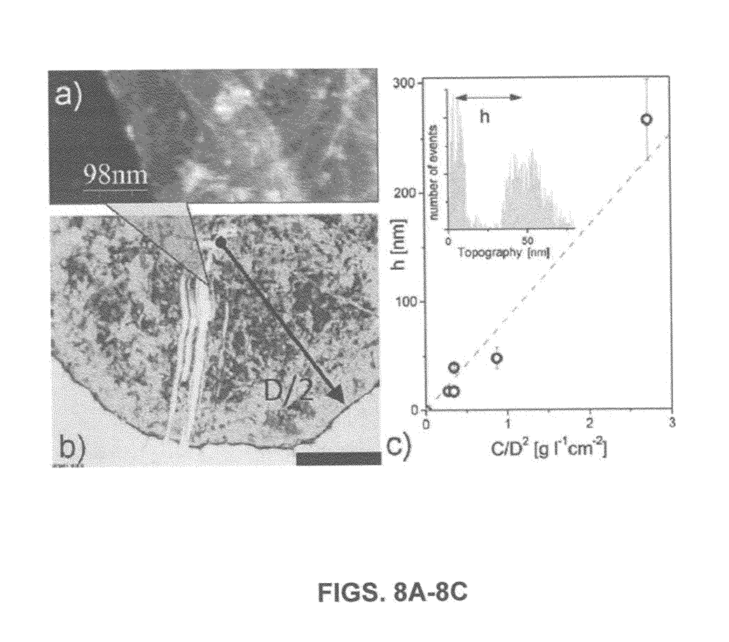

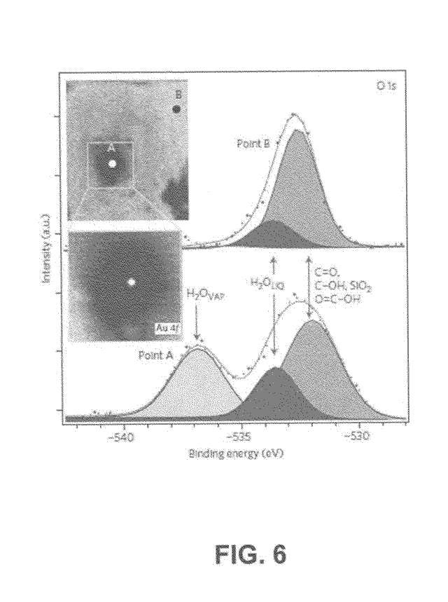

Next, the feasibility of conducting photoelectron spectromicroscopy of liquid media was tested by filling the E-cell compartment with 3M Nal aqueous solution, and subsequently vacuum sealing it using the procedure described above. It was found that a few nanometer-thick GO membrane is capable of maintaining the liquid and/or elevated-pressure water (vapor) for an extended period of time for conventional XPS studies. Some interfacial diffusion between the GO layers and the primary silicon nitride membrane was observed in only a few cells after long experiments. Similar phenomena, namely interfacial mass transport and trapping of water layers have also been observed. The vacuum tightness of the E-cell front side is determined by the initial adhesion of the GO sheets to the silicon nitride window, which, in some embodiments, may be enhanced by some thermal annealing. These samples sustained the UHV environment for a plurality of hours of continuous measurements and experimentation. For example, FIG. 6 shows representative oxygen 1s spectra taken at the points indicated in the gold 4f_{7/2} images, namely at point A, where the GO membrane isolates the 3 M Nal aqueous solution form the vacuum, and in the dry GO membrane-covered area about 30 μm away at point B. The oxygen 1s spectrum from point B on the gold-covered SiN is similar to the standard oxygen 1s XPS spectrum of partially reduced GO, as has been previously reported, with a small contribution from water presumably trapped at the interface or between the GO sheets and the substrate. The oxygen 1s spectrum of point A is different, which may be due to the pronounced components corresponding to the liquid and vapor phases of water. The concomitant XPS features in the region of iodine 4d, sodium 2s, and sodium 2p correspond to the presence of I⁻ and Na⁺ solvated ions, which may be too weak to be unambiguously assigned, possibly due to the low ion concentrations and a relatively thick GO membrane. However, the above data show that some embodiments of the invention are capable of use for environmental electron spectroscopy in membrane-based E-cells.

In some other circumstances, graphene-based membranes were generated and tested (data not shown). In these circumstances, the graphene-based membranes were produced as discussed below.

Graphene was assembled on copper foil using chemical vapor deposition to fabricate single layer graphene membranes or sheets while multilayer graphene sheets were grown on nickel film on a silicon wafer, with the latter being used to produce thicker and more robust windows. Commercial stainless steel frames (Lenox Laser Inc. 10 mm in diameter and 0.05-0.1 mm thick) having laser drilled apertures with diameters of between about 2 and about 10 microns were used as exchangeable supporting frames for at least some of the windows. Prior to graphene transfer, the orifices were electro polished in a 45% phosphoric acid, 30% sulfuric acid, and 25% glycerol (by volume) solution to eliminate the laser induced edge roughness near the aperture. Graphene was transferred to these To transfer graphene to these stainless steel frames using a conventional Poly(methyl methacrylate) (PMMA)-based protocol substantially similar to the protocol described in Li et al, “Transfer of Large-Area Graphene Films for High-Performance Transparent Conductive Electrodes,” 9 Nano Letters 4369 (2009), which is herein incorporated by reference in its entirety.

Briefly, after transfer of the PMMA and the graphene layer from the distilled water onto a target substrate, the assembly was dried in air and then exposed to saturated acetone vapor above a 65° C. acetone bath to induce gradual softening and melting of the polymer support. This procedure can eliminate the effect of mesoscopic interfacial roughness of the contact between graphene and the support frame/substrate and ensure adhesion of the graphene to the substrate. The polymer film softening and melting was visually monitored and controlled in real time with optical microscope. After the complete adhesion of melted polymer was achieved the entire assembly was slowly immersed in to the hot acetone bath to dissolve completely PMMA film. A second warm bath of acetone was used for final cleaning of the window to remove some or all possible remaining polymer residue. This additional cleaning of the window in the second acetone bath was found to be helpful because the organic residue can form with the high-aspect ratio, few micrometer wide aperture of the support frame upon drying if not cleaned with solvent. Moreover, in some embodiments, the above-described protocol works using a drop-cast method (as discussed in Example 2) with lacquer diluted 1:10 in acetone in lieu of the PMMA.

### Example 2

### Materials and Methods

A GO dispersion in water of 1 mg/mL was obtained using a modification of Hummers method, which was disclosed in Hummers, W. S. & Offeman, R. E., “Preparation of Graphitic Oxide,” J. Am. Chem. Soc. 80 1339 (1958), which is herein incorporated in its entirety by reference. As a result of this protocol, GO sheets were produced with a size on the order of a few to a few tenths of a micron. Discs made of Cu, Ni, and stainless steel were used in the following experiments. For example, electrochemically formed and/or laser-drilled metal aperture discs were used. In some experiments, SiN, SiO₂, and ruby discs were also used. The aperture diameters ranged from about 4 to about 50 μm.

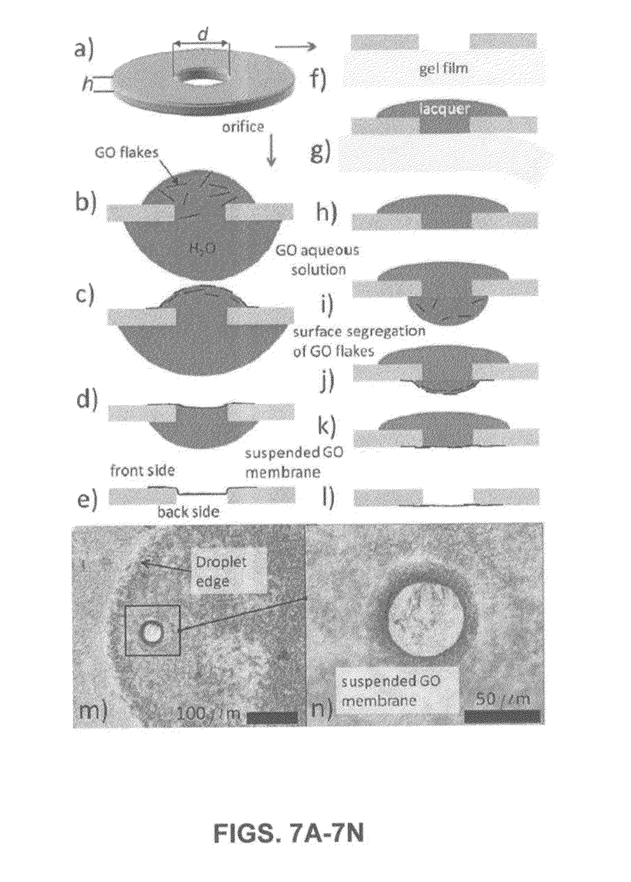

As shown in FIGS. 7A-7L, different methods were used to form the GO membranes or windows over the aperture of the discs. In particular, depending on a diameter d of the aperture and a height h of the discs, different methods were used to fabricate the GO windows. First, referring first to FIGS. 7A-7E, in the case of relatively smaller apertures (e.g., about 4-10 μm), a first drop-cast method can be used. For example, in some embodiments, after preparing the GO dispersion mentioned above, two droplets were placed on opposing sides of the disc, as shown in FIG. 7B. A first droplet that consists essentially of water can be placed on a first side of the disc and a second droplet that consists essentially of the GO dispersion solution can be placed on a second, opposing side of the disc using a calibrated micropipeter. In some circumstances, the first droplet can have about a ten times-greater volume than the second droplet (e.g., 20-30 μL v. 2-3 μL). Because of the amphiphilicity of the GO sheets in the GO dispersion solution, the GO sheets, which are initially homongenously distributed within the second droplet, become segregated at the air-water interface of the second droplet, as shown in FIG. 7C, which leads to the GO membrane self-assembling at the air-water interface. At this initial stage, the nascent GO membrane is partially permeable to water vapor due to the incomplete overlapping of the GO sheets and/or the presence of hydrophobic patches within partially overlapping GO sheets. Referring now to FIG. 7D, as the water evaporates, the GO membrane gradually becomes denser at the air-water interface. As the second droplet evaporates, the first droplet remained for a longer period of time (i.e., because of its greater volume, it takes longer to evaporate), thereby functioning as a support medium for the GO membrane while drying occurs. In addition, as the water evaporated, acetone was added to the disc to minimize the surface tension coefficient, thereby reducing the risk of capillary-induced collapse of the GO membrane during later stages of drying.

Referring now to FIGS. 7F-7L, the second method is designed for the deposition of a GO membrane on one side of discs with a larger apertures (e.g., about 10-50 μm). Initially, the disc is placed on a fresh gel film that reversibly adheres to a surface of the disc and closes off one side of the aperture, as shown in FIGS. 7F and 7G. Then, a lacquer or other water-insoluble material (e.g., Poly(methyl methacrylate), acetone liquid nail polish, etc.) was casted onto the opposing side of the disc. After drying of the lacquer drop, the gel film was removed, as shown in FIG. 7H. A drop of GO dispersion solution was then placed over the filled aperture, as shown in FIG. 7I, and allowed to slowly dry, as in the method discussed above, and as shown in FIGS. 7J and 7K. After drying, the polymer support was dissolved in acetone to create the free-standing membrane seen in FIG. 7I.

Regardless of the method of manufacture, all membranes were allowed to substantially or completely dry at 125±5° C. for approximately 30 minutes. This drying step eliminates any excess water caught between layers of the GO membrane, strengthens the membrane, improves impermeability of the membrane, and improves the membranes adhesion to the disc.

### Results and Discussion

Unlike conventional SiO₂ or SiN membrane microfabrication technologies, the above-described methods offer the opportunity to create the membranes selectively at predefined locations with adjustable thickness. For example, the thickness H of the membrane can be controlled via dilution level of the concentration of the primary GO dispersion solution (C_{GO}) and/or controlled via the diameter D of the contact area of the droplet of GO dispersion using the following equation:

H=(4V_{L}πρ_{GO})(C_{GO}/D²) (3)

Where V_{L} and ρ_{GO} are the initial volume of the droplet and the density of the formed GO membrane, respectively. Since the droplet contact line remains pinned during the drying process, the thickness can be controlled within the range of from a few to hundreds of nanometers, as discussed in greater detail below.

For example, a possible diameter of the contact area of the droplet on a Si/SiO₂ wafer and on metal apertures was on the order of 1 mm under normal conditions and can be adjusted or modulated by modifying the wetting properties of the wafer or creating a hydrophobic barrier of a predefined diameter using a liquid blocker.

In order to examine this dependence, an array of 3 μL droplets with different concentrations of GO was allowed to dry on a clean Si/SiO₂ surface. After drying, part of the residual GO film/membrane was mechanically removed along the radius and step height histograms were measured using AFM at different locations along the ridge, as shown in FIGS. 8A and 8B. FIG. 8C depicts the experimentally obtained average height values as a function of the GO dilution level C_{GO} and drop contact diameter D. Nearly linear dependence confirms that the film/membrane thickness is homogenous along the diameter and no significant “coffee-ring effect” was observed.

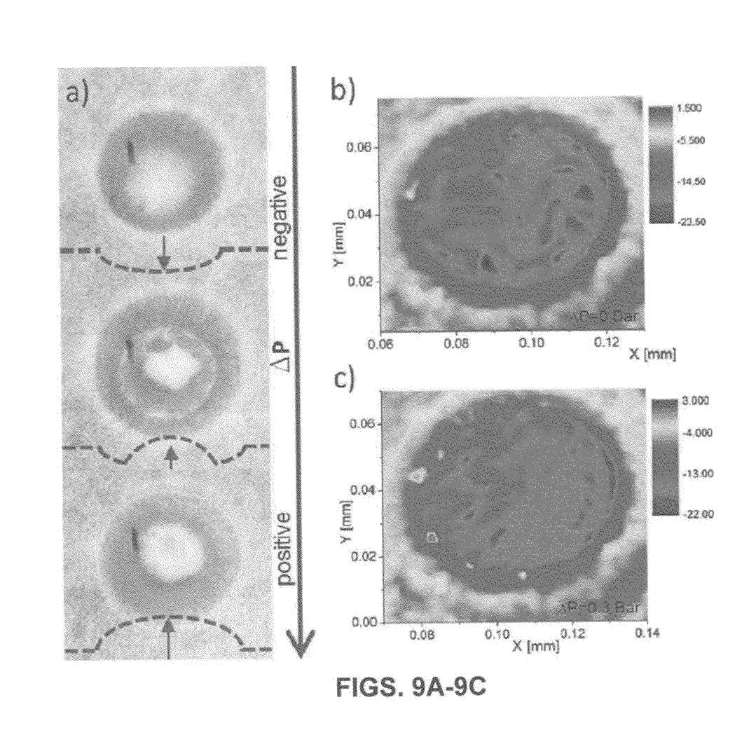

Next, a cell having a gas inlet and connection to an accurate pressure gauge was designed to facilitate monitoring of the morphological changes and deflections of the membrane during pressurization. The topology of a 40 nm thick membrane suspended over a 50 μm aperture is depicted in FIGS. 7M and 7N (and at a higher magnification in FIG. 9). The rippled surface of the GO membrane is due to the fact that the GO membranes are usually formed on a concaved/convex surface of the droplet, depending on its drying configuration. In addition, different expansion coefficients and slipping of the GO membrane on the support surface during the annealing and cooling cycle can also contribute to the observed configurations. The formation of concave/convex membranes can lead to a “flip-flopping” behavior upon pumping, as seen in FIG. 9A. For suspended membranes as large as 50 μm in diameter, the height variations between “valleys” and “hills” can reach a few microns. In some embodiments, optical profilometry can be employed for quantitative analysis of the membrane morphology and mechanics during pressurization, as seen in FIGS. 9B and 9C. As a result of the pressure differential, most of the slack of the GO membrane can be removed, with flattening generally occurring at ΔP<10⁴ Pascal (Pa). Further increases in pressure lead to the development of tensile strain in the membrane and its potential disruption.

For example, more than 30 membranes with thicknesses between 20 and 250 nm and orifice diameters between 4 and 50 μm were tested. The data shows that 50 μm membranes with a thickness of about 30-50 nm were found to be a workable compromise between mechanical stability and electron transparency. These GO membranes were generally able to withstand a pressure differential of up to 1.3×10⁵ Pa, which is sufficient for most practical needs of environmental electron microscopy; however smaller membranes (e.g., those less than 10 μm in diameter) can withstand similar (e.g., higher) pressure differentials.

Similarly, the tensile strength σₘₐₓ of GO membranes was also evaluated using the bulge test method. Measuring the bulge height h (after removal of the initial slack) and Pₘₐₓ of the pressurized suspended membrane, along with the thickness t and diameter D just before the failure for typical 40 nm thick and 50 μm wide membranes, the average stress σₘₐₓ was evaluated to be about 80 MPa.

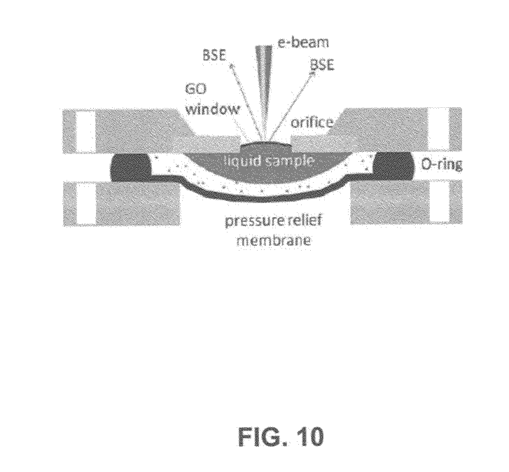

FIG. 10 illustrates one of the tested designs of an experimental E-cell. The cell was made from two metal discs and was sealed with a pressure relief rubber membrane gasket. The gasket served to isolate the approximately 20 μL compartment and eliminated some or all potential overpressures, which could have disrupted the GO membrane when the sample contained trapped gas. This cell is capable of preserving an interior wet environment for an extended period of time (e.g., greater than one or more months). The interfacial water diffusion between the GO membrane and the supporting frame was found to be one of the possible channels for vacuum leaking, including cases where the GO membrane was pressurized from the back, such as is shown in FIG. 7E. This potential for vacuum leakage can be reduced by flipping the supporting frame and using the GO membrane-covered plane as the cell's interior surface, such as is shown in FIG. 71.

A relevant consideration for conducting SEM imaging with membrane-based E-cells is the proximity of the sample to the backside of the membrane. The liquid containing samples, such as nanoparticle solutions, can be casted directly on to the backside of the GO membrane, as discussed above in Example 1. The adhered nanoparticles become immobilized at the backside of the membrane and therefore can be imaged. However, free nanoparticles in Brownian motion may move too fast compared to the beam rastering rate. The placing of nonplanar or large rigid samples that do not adhere to the GO membrane surface may not be realized by mechanically pressing them against the membrane because this may cause disruption of the membrane. To overcome this potential limitation, an encapsulation methodology can be used. This methodology may employ a secondary drop-casted GO membrane as a capping agent (i.e., to form a GO-membrane “sandwich” with the analyte between two GO membranes). As a result of this method, samples can be gently adhered to the surface of the electron-transparent membrane while the wet environment around the sample is preserved.

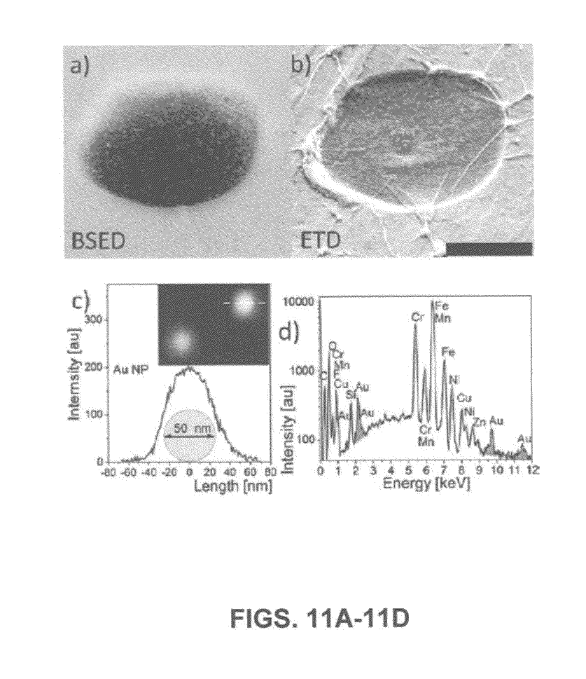

FIGS. 11A and 11B depict SEM images of closed wet cells equipped with 10 μm GO membranes filled with a gold nanoparticle solution. These images were obtained under the same conditions using back-scattered electron detector (BSED) and Everhart-Thornley detector (ETD), respectively. Since ETD is sensitive to low energy secondary electrons, greater detail of the membrane surface morphology can be seen in FIG. 11B. The profile analysis, which is shown in FIG. 11C, of the individual 50 nm gold nanoparticles revealed that a 20-40 nm thick GO membrane does not deteriorate the resolution of the microscope for the objects attached to or in close proximity (e.g., 0-50 nm) to the back side of the GO membrane. FIG. 11D illustrates that the EDX analysis can be routinely performed on the objects immersed in the water.

An analysis of images taken with the ETD as a function of the beam energy reveals particularities of the contrast formation mechanism. Using some embodiments of the invention, it was possible to image gold nanoparticles through the GO membrane using low electron beam energies (e.g., around 2 keV or greater). Since the thickness of the GO membrane (20-40 nm) at least partially exceeds the inelastic mean free path for second electrons in GO, it is plausible that the SEM signal from gold nanoparticles is formed mainly by secondary electrons of S_{II} and S_{III} induced by electrons backscattered from the gold nanoparticles.

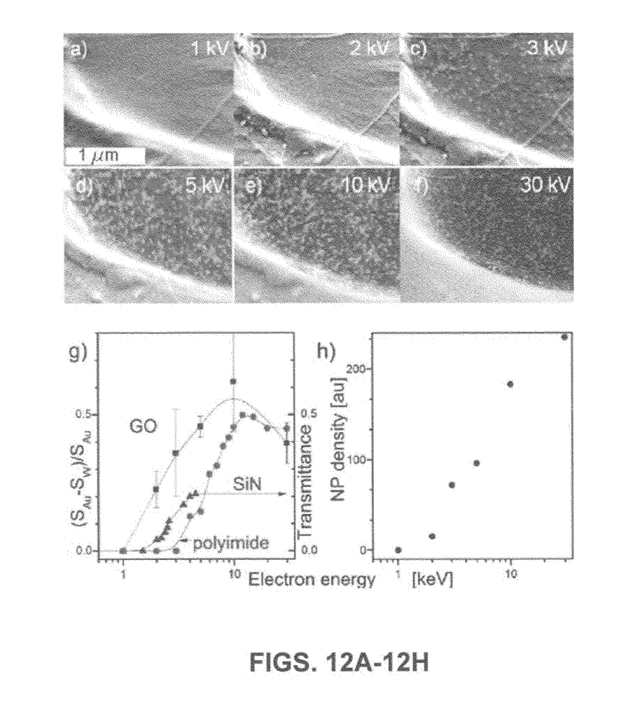

Referring now to FIGS. 12A-12H, a qualitative evaluation of the electron transparency of GO membranes was studied using the dependence of the gray-scale difference between gold nanoparticles and water (S_{Au}−S_{W}/S_{Au}) as a function of electron beam energy, as shown in the black squares of FIG. 12G. These results were compared with experimental data (triangles and circles in the same figure). Interestingly, the GO membrane becomes reasonably transparent for electrons already at 2 keV, which significantly outperforms conventional membrane materials (polyimide and SiN). The complementing analysis of the apparent density of the nanoparticles as a function of the beam energy indicated a gradual increase in observable nanoparticles with excitation energy, which may be due to increased range of higher energy electrons. This phenomenon allows probing through the thicker patches of the GO membrane and/or a greater depth into the water than conventional systems.

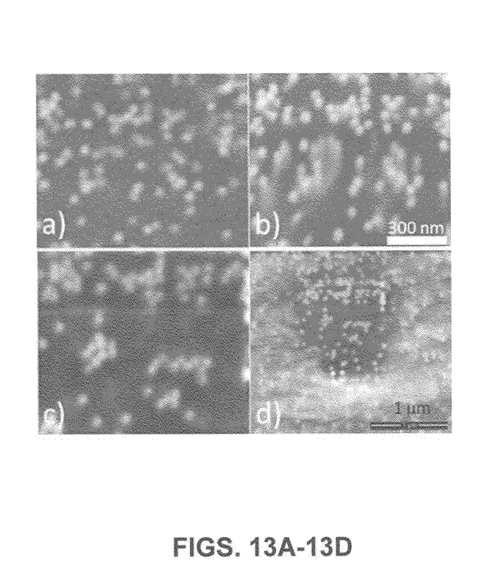

Additionally, electron-beam-induced direction movement of nanoparticles that were weakly bound to the backside of the GO membrane was also observed. FIGS. 13A-13C represent three sequential scans over the same area of the membrane, which covered a solution of 50 nm of gold nanoparticles. Although the scans depicted in FIGS. 13A and 13C were recorded at the rastering rate of about 4×10⁵ nm/s, the scan in FIG. 13B was recorded at the slower rate of 32×10⁴ nm/s. The appearance of “ghost” traces in FIG. 13C is an indication that the gold nanoparticles become mobile during the scan. The effect of relocation of the nanoparticles can be seen by direct comparison of the image of FIGS. 13A and 13C and the zoomed-out image of FIG. 13D. This implies that the prolonged interaction of the electron beam with a weakly adhered nanoparticles creates a dragging force. In addition, it was observed that prolonged exposure of the same GO membrane area to an electron beam with the areal dose of 10 C/cm2 may lead to darkening, as shown in FIG. 13D and some morphological changes of the membrane itself.

As discussed above, some embodiments of the invention provide for a window/membrane composition for environmental cells to enable XPS and other imaging studies using a liquid or dense gaseous media. As discussed above, a plurality of layers of suspended GO sheets assemble to form GO membranes and have sufficient transparency to function as photo-suspended membranes. Moreover, in some embodiments, the GO membranes have sufficient transparency for photo-emitted electrons with kinetic energies less than, equal to, or greater than 450-500 eV. The results discussed above indicate that in addition the their unique electronic, thermal, magnetic, mechanical, and other properties, the two-dimensional and quasi-two-dimensional crystals, such as graphene, GO, GN, MoS₂, NbSe₂, Si₂Sr₂CaCu₂Oₓ, Bi₂Te₃, and others, appear to provide an improved platform for experimental XPS tests of interfacial, electron transport, and inelastic phenomena in solids because the morphology and the thickness of such an over-layer can be nearly or completely precisely determined.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method of preparing a carbon-containing membrane, the method comprising:
preparing a carbon-containing solution;
filtering and washing the carbon-containing solution;
adding a volume of the filtered and washed carbon-containing solution to a receptacle comprising an aqueous solution;
waiting a predetermined amount of time to allow the carbon-containing solution to form a plurality of carbon-containing sheets;
defining at least one aperture through at least a portion of a substrate; and
inserting the substrate into the receptacle so that at least a portion of the carbon-containing sheets adhere to the substrate and cover the at least one aperture.

2. The method of claim 1 and further comprising depositing a layer of an inert metal on the substrate prior to insertion into the receptacle.

3. The method of claim 1 and further comprising sealing the substrate.

4. The method of claim 1, wherein the aqueous solution is water.

5. The method of claim 1, wherein the predetermined amount of time is at least twenty minutes.

6. The method of claim 1 and further comprising thermally treating the substrate after insertion into the receptacle to modulate at least one property of the carbon-containing sheets.

7. The method of claim 1, wherein the carbon-containing material comprises at least one of graphene oxide and graphene.
